(19) United States
(12) Patent Application Publication
(10) Pub. No.: US 2024/0306045 A1
(43) Pub. Date: Sep. 12, 2024

(54) METHOD FOR SESSION UPDATE AFTER SESSION MANAGEMENT FUNCTION FAILURE AND RESELECTION

(71) Applicant: ZTE CORPORATION, Shenzhen (CN)

(72) Inventors: Menghan WANG, Shenzhen (CN); Zhijun LI, Shenzhen (CN); Shuang LIANG, Shenzhen (CN)

(73) Assignee: ZTE CORPORATION, Shenzhen (CN)

(21) Appl. No.: 18/604,735

(22) Filed: Mar. 14, 2024

Related U.S. Application Data
(63) Continuation of application No. PCT/CN2021/143138, filed on Dec. 30, 2021.

(51) Int. Cl. H04W 36/00; H04W 36/12

(52) U.S. Cl. CPC H04W 36/0011; H04W 36/12

(57) ABSTRACT

A wireless communication method for use in a first session management function (SMF) is disclosed. The method comprises taking over control of a protocol data unit, PDU, session served by a second SMF, and transmitting, to at least one network function associated with the PDU session, SMF change information associated with the PDU session.

### CROSS-REFERENCE TO RELATED PATENT APPLICATIONS

This application is a Continuation of PCT Application No. PCT/CN2021/143138, filed Dec. 30, 2021, incorporated herein by reference in its entirety.

### TECHNICAL FIELD

This document is directed generally to wireless communications, including but not limited to 5th generation (5G) communications.

### BACKGROUND

In a 5G system, a user equipment (UE) may request a protocol data unit (PDU) session establishment to the network, to get an internet protocol (IP) connectivity service. In this case, a session management function (SMF) is selected to control the established PDU session and such SMF is called anchor SMF. In addition, a user plane function (UPF) selected by the anchor SMF to allocate UE IP address is called PDU Session Anchor (PSA) or PSA UPF.

### SUMMARY

Generally speaking, the anchor SMF and the PSA UPF have their own serving areas and cannot serve the whole network (e.g., public land mobile network (PLMN)). In order to support the PDU session service when the UE is out of the service area supported by the anchor SMF and the PSA UPF, an Intermediate SMF and an Intermediate UPF are inserted to serve the UE location area (i.e., the area at which the UE is located). For example, the Intermediate SMF may be a visited SMF (V-SMF) in a Home-Routed roaming scenario or an I-SMF in a non-roaming scenario. Accordingly, the Intermediate UPF may be a visited UPF (V-UPF) in the Home-Routed roaming scenario or an I-UPF in the non-roaming scenario.

The PDU session may be involved with the intermediate SMF or without the intermediate SMF. In the PDU session without the intermediate SMF, the anchor SMF maintains session management (SM) Context and PDU Session Context for the UE. In the PDU session involving the intermediate SMF, the SM Context is maintained by the intermediate SMF and the PDU Session Context is maintained by the anchor SMF. The intermediate SMF allocates an SM Context ID which is used to locate the SM Context in the intermediate SMF. The SM context contains necessary information associated with an access and mobility management function (AMF) and N3 tunnel(s), such as AMF information, N3 tunnel info, etc. The PDU Session Context contains, e.g., UE IP address, PDU session policy information, N6 tunnel info, etc.

The anchor SMF is one of the most important network functions (NFs) serving the PDU session in the 5G system. Once the anchor SMF fails or works abnormally, the UE may completely lose its IP connectivity service. To avoid the IP connectivity service interruption, an alternative anchor SMF may be chosen to take over the PDU session once the original anchor SMF fails.

In the 5G system, a general concept of NF Set is introduced to support the NF failure and restoration with less impact to the service continuity. The concept of the NF Set is designed in the 5G system to support stateless deployment of an NF and is commonly used in NF failure and restoration cases. Specifically, NFs within the same NF Set share the resources (e.g., UE IP address resources) and session contexts (e.g., UE PDU session contexts). If a failure of one NF is detected by another NF, the detecting NF can select one NF within the same NF Set of the failed NF to continue the service procedure.

Furthermore, a Packet Forwarding Control Protocol (PFCP) Association may be set up between the SMF and the UPF prior to establishing the first PFCP session on that UPF. During the PFCP Association Setup procedure, the SMF may send SMF Set information to the UPF. The UPF may use the SMF Set information to transfer one PFCP session from a failed SMF to another SMF within the same SMF Set.

The UPF runs periodical keep-alive detection (e.g., using a Heartbeat procedure) with the SMFs to which the UPF connects. Once the UPF detects that one SMF fails (e.g., the SMF is not responsive), the UPF reselects another SMF within the SMF Set to take over the control of the impacted PFCP Session(s). As per the existing procedure, the AMF may also reselect a new SMF within the SMF Set when the AMF detects that the old SMF fails (e.g., the old SMF is not responsive) and send PDU Session related messages to the SMF reselected by the AMF. However, the SMF reselected by the AMF may be different from the SMF reselected by the UPF. Under such conditions, the SMF reselected by the AMF may need to redirect the PDU Session related messages received from the AMF to the SMF reselected by the UPF, resulting in additional signaling exchanges and procedure complexity. Furthermore, potential signal transmission time-out errors may occur.

Therefore, this disclosure provides methods to allow the reselected SMF to proactively update the SMF information of the PDU Session to other NFs, e.g., AMF and PCF, in the case when the UPF reselects another SMF to serve the PDU session.

This document relates to methods of allowing the reselected SMF to proactively update the SMF information of the PDU Session to other network functions (NFs), and in particularly to methods of allowing the reselected SMF to proactively update the SMF information of the PDU Session to other NFs when the UPF reselects the SMF to take over control of the PDU session from another SMF.

The present disclosure relates to a wireless communication method for use in a first session management function (SMF). The method comprises:
taking over control of a protocol data unit, PDU, session served by a second SMF, and
transmitting, to at least one network function associated with the PDU session, SMF change information associated with the PDU session.

Various embodiments may preferably implement the following features:

Preferably or in some embodiments, the SMF change information comprises an identifier of the first SMF.

Preferably or in some embodiments, the SMF change information further comprises at least one of:
an identifier of the second SMF,
an identifier of a first SMF set comprising the first SMF,
an identifier of a second SMF set comprising the second SMF, or
a transfer indication indicating at least one PDU session on which the SMF change information is applied.

Preferably or in some embodiments, the transfer indication indicates a single PDU session or a plurality of PDU sessions served by the second SMF.

Preferably or in some embodiments, taking over control of the PDU session served by the second SMF comprises:
receiving, from a user plane function, a request of taking over control of a packet forwarding control protocol session corresponding to the PDU session from the second SMF.

Preferably or in some embodiments, the at least one network function comprises at least one of an access and mobility management function, a policy control function, a unified data management, an intermediate SMF or a visited SMF.

Preferably or in some embodiments, the at least one network function comprises a policy control function, and the SMF change information transmitted to the policy control function further comprises a notification uniform resource identifier of a recipient of a session management policy update notification.

The present disclosure relates to a wireless communication method for use in an intermediate session management function (SMF). The method comprises:
receiving, from a first SMF, SMF change information associated with a protocol data unit, PDU, session served by a second SMF, and
transmitting, to an access and mobility management function associated with the PDU session, the SMF change information.

Various embodiments may preferably implement the following features:

Preferably or in some embodiments, the SMF change information comprises an identifier of the first SMF.

Preferably or in some embodiments, the SMF change information further comprises at least one of:
an identifier of the second SMF,
an identifier of a first SMF set comprising the first SMF,
an identifier of a second SMF set comprising the second SMF, or
a transfer indication indicating at least one PDU session on which the SMF change information is applied.

Preferably or in some embodiments, the transfer indication indicates a single PDU session or a plurality of PDU sessions served by the second SMF.

The present disclosure relates to a wireless communication method for a network function. The method comprises:
receiving, from a first session management function, SMF, SMF change information associated with a protocol data unit, PDU, session served by a second SMF, and
updating SMF information of at least one PDU session based on the SMF change information.

Various embodiments may preferably implement the following features:

Preferably or in some embodiments, the SMF change information comprises an identifier of the first SMF.

Preferably or in some embodiments, the SMF change information further comprises at least one of:
an identifier of the second SMF,
an identifier of a first SMF set comprising the first SMF,
an identifier of a second SMF set comprising the second SMF, or
a transfer indication indicating at least one PDU session on which the SMF change information is applied.

Preferably or in some embodiments, the transfer indication indicates a single PDU session or a plurality of PDU sessions served by the second SMF.

Preferably or in some embodiments, the SMF change information comprises a transfer indication indicating single PDU session or does not comprise the transfer indication, and updating the SMF information of the at least one PDU session based on the SMF change information comprises:
updating the SMF information of the PDU session based on the SMF change information.

Preferably or in some embodiments, the SMF change information comprises a transfer indication indicating a plurality of PDU sessions served by the second SMF, and updating the SMF information of the at least one PDU session based on the SMF change information comprises:
updating the SMF information of the plurality of PDU sessions served by the second SMF based on the SMF change information.

Preferably or in some embodiments, the network function comprises at least one of an access and mobility management function, a policy control function or a unified data management.

Preferably or in some embodiments, the network function comprises an access and mobility management function, and the SMF change information is received via an intermediate SMF.

Preferably or in some embodiments, the network function comprises a policy control function, and the SMF change information further comprises a notification uniform resource identifier of a recipient of a session management policy update notification.

The present disclosure relates to a wireless device having a first session management function (SMF). The wireless device comprises:
a processor, configured to take over control of a protocol data unit, PDU, session served by a second SMF, and
a communication unit, configured to transmit, to at least one network function associated with the PDU session, SMF change information associated with the PDU session.

Various embodiments may preferably implement the following feature:

Preferably or in some embodiments, the processor is further configured to perform any of the aforementioned wireless communication methods.

The present disclosure relates to a wireless device having an intermediate session management function (SMF). The wireless device comprises:
a communication unit, configured to:
receive, from a first SMF, SMF change information associated with a protocol data unit, PDU, session served by a second SMF, and
transmit, to an access and mobility management function associated with the PDU session, the SMF change information.

Various embodiments may preferably implement the following feature:

Preferably or in some embodiments, the wireless device further comprises a processor configured to perform any of the aforementioned wireless communication methods.

The present disclosure relates to a wireless device having a network function. The wireless device comprises:
a communication unit, configured to receive, from a first session management function, SMF, SMF change information associated with a protocol data unit, PDU, session served by a second SMF, and
a processor configured to update SMF information of at least one PDU session based on the SMF change information.

Various embodiments may preferably implement the following feature:

Preferably or in some embodiments, the processor is further configured to perform any of the aforementioned wireless communication methods.

The present disclosure relates to a computer program product comprising a computer-readable program medium code stored thereupon, the code, when executed by a processor, causing the processor to implement a wireless communication method recited in any one of foregoing methods.

The example embodiments disclosed herein are directed to providing features that will become readily apparent by reference to the following description when taken in conjunction with the accompany drawings. In accordance with various embodiments, example systems, methods, devices and computer program products are disclosed herein. It is understood, however, that these embodiments are presented by way of example and not limitation, and it will be apparent to those of ordinary skill in the art who read the present disclosure that various modifications to the disclosed embodiments can be made while remaining within the scope of the present disclosure.

Thus, the present disclosure is not limited to the example embodiments and applications described and illustrated herein. Additionally, the specific order and/or hierarchy of steps in the methods disclosed herein are merely example approaches. Based upon design preferences, the specific order or hierarchy of steps of the disclosed methods or processes can be re-arranged while remaining within the scope of the present disclosure. Thus, those of ordinary skill in the art will understand that the methods and techniques disclosed herein present various steps or acts in a sample order, and the present disclosure is not limited to the specific order or hierarchy presented unless expressly stated otherwise.

The above and other aspects and their implementations are described in greater detail in the drawings, the descriptions, and the claims.

### BRIEF DESCRIPTION OF THE DRAWINGS

FIG. 1 shows a schematic diagram of a 5G Home-Routed roaming architecture according to an embodiment of the present disclosure.

FIG. 2 shows a schematic diagram of a 5G non-roaming architecture according to an embodiment of the present disclosure.

FIG. 3 shows a schematic diagram of a PDU session establishment procedure according to an embodiment of the present disclosure.

FIG. 4 shows a schematic diagram of a PFCP Association Setup procedure according to an embodiment of the present disclosure.

FIG. 5 shows a schematic diagram of a procedure according to an embodiment of the present disclosure.

FIG. 6 shows a schematic diagram of a procedure according to an embodiment of the present disclosure.

FIG. 7 shows a schematic diagram of a procedure according to an embodiment of the present disclosure.

FIG. 8 shows an example of a schematic diagram of a wireless terminal according to an embodiment of the present disclosure.

FIG. 9 shows an example of a schematic diagram of a wireless network node according to an embodiment of the present disclosure.

FIG. 10 shows a flowchart of a method according to an embodiment of the present disclosure.

FIG. 11 shows a flowchart of a method according to an embodiment of the present disclosure.

FIG. 12 shows a flowchart of a method according to an embodiment of the present disclosure.

### DETAILED DESCRIPTION

In the present disclosure, the term “information” is equal to or has the same meaning as “info”.

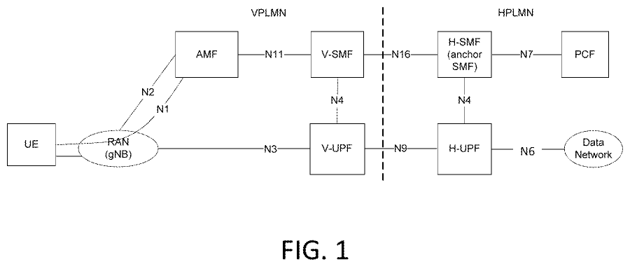

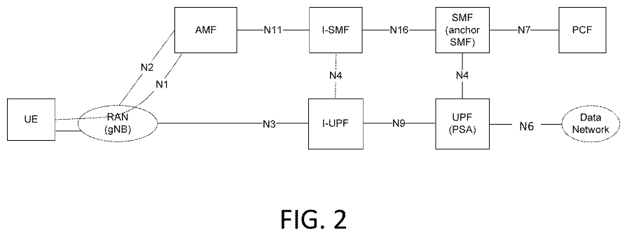

FIG. 1 shows a 5G Home-Routed roaming architecture according to an embodiment of the present disclosure. In FIG. 1, the anchor SMF and PSA UPF cannot directly serve a visited PLMN (VPLMN) on which the UE camps. FIG. 2 shows a 5G non-roaming architecture according to an embodiment of the present disclosure. In FIG. 2, the anchor SMF and the PSA UPF cannot directly serve the area in which the UE is located (i.e., UE location area). In FIGS. 1 and 2, there are the following network functions and network entities:
1) UE (User Equipment)
2) RAN (Radio Access Network (node)):

In the 5G network, the RAN may be a new radio (NR) base station.
3) AMF (Access and Mobility Management function):

The AMF includes the following functionalities: Registration management, Connection management, Reachability management and Mobility Management. The AMF also performs the access authentication and access authorization. The AMF is the non-access stratum (NAS) security termination and relays the SM NAS between the UE and the SMF, etc.
4) SMF (Session Management Function)

The SMF includes the following functionalities: session establishment, modification and release, UE IP address allocation and management (including optional authorization functions), selection and control of UP function, downlink data notification, etc. The SMF controls the UPF via N4 association.
5) UPF (User plane function)

The UPF includes the following functionalities: serving as an anchor point for intra-/inter-radio access technology (RAT) mobility, packet routing and forwarding, traffic usage reporting, QoS handling for the user plane, downlink packet buffering and downlink data notification triggering, etc. The UPF may be deployed as an intermediated UPF (I-UPF) or a PSA. The PSA/UPF is the UPF terminating the N6 interface towards the data network. The I-UPF provides traffic forwarding between the RAN and PSA/UPF. The I-UPF may support “ULCL” (Uplink classifier: offloading uplink traffic based on target IP address) or “BP” (Branching point: offloading uplink traffic based on source IP address) to offload some traffics to local PSA/UPF.
6) PCF (Policy Control Function)

The PCF provides QoS policy rules to control plane functions to enforce the rules. The PCF(s) transform(s) the AF requests into policies that apply to PDU Sessions. The PCF provides the AF influenced Traffic Steering Enforcement Control in PCC rules to SMF so the SMF can establish the data path to offload the traffic to local data network.
7) AF (Application Function)

The AF interacts with the 3GPP Core Network in order to provide services, e.g., to support application influence on traffic routing. Based on operator deployment, the AFs considered to be trusted by the operator can be allowed to interact directly with relevant Network Functions. The AFs not allowed by the operator to access directly the Network Functions shall use the external exposure framework via a network exposure function (NEF) to interact with relevant Network Functions.

In a PDU Session Establishment procedure, if the selected anchor SMF and the PSA UPF cannot serve the area where the UE camps on, an I-SMF and an I-UPF need to be inserted (see FIG. 2). The visited SMF (V-SMF) shown in FIG. 1 (i.e., Home-Routed roaming scenario) plays a similar role of the I-SMF shown in FIG. 2 (i.e. non-roaming scenario). Thus, the I-SMF may be equal to V-SMF in the present disclosure. Similarly, the I-UPF may be equal to the visited UPF (V-UPF) shown in FIG. 1 in the present disclosure.

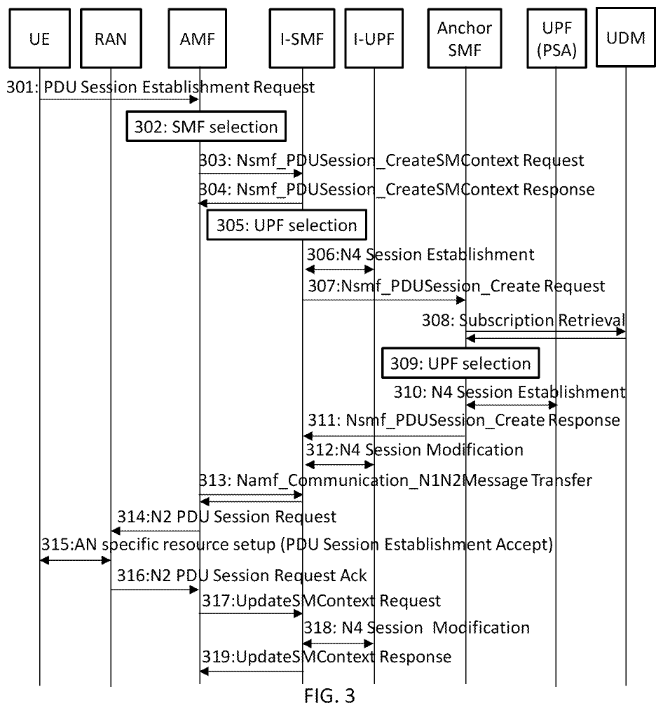

FIG. 3 shows a schematic diagram of a PDU session establishment procedure according to an embodiment of the present disclosure. The PDU session establishment procedure in FIG. 3 involves an I-SMF insertion. Specifically, after the UE registered to a 5G network, the UE may request a PDU session establishment procedure comprising the following steps:
Step 301: The UE transmits a PDU Session Establishment Request to the AMF.

The PDU Session Establishment Request is included in a non-access stratum (NAS) message and encapsulated in a N1 SM container. The NAS message may comprise Single Network Slice Selection Assistance information (S-NSSAI), UE Requested data network name (DNN), PDU Session ID, Request type, and N1 SM container (comprising the PDU Session Establishment Request). The NAS message sent by the UE is encapsulated by the RAN in a N2 message towards the AMF.
Step 302: The AMF selects a proper SMF (i.e., anchor SMF), to serve the PDU session, based on the requested DNN, the S-NSSAI and current UE location information. If the anchor SMF cannot serve the current location of the UE, the AMF determines to also select an I-SMF for the PDU session.
Step 303: The AMF transmits a Nsmf_PDUSession_CreateSMContext Request to the I-SMF, wherein the Nsmf_PDUSession_CreateSMContext Request comprises a Subscription Permanent Identifier (SUPI), selected DNN, UE requested DNN, S-NSSAI(s), PDU Session ID, AMF ID, Request Type, N1 SM container (PDU Session Establishment Request), User location information, Access Type, RAT Type, Permanent Equipment Identifier (PEI), General Public Subscription Identifier (GPSI), AMF callback URI for receiving SM context status notification, etc. The SUPI uniquely identifies the UE subscription. The AMF ID carries a Globally Unique AMF ID (GUAMI) uniquely identifying the AMF serving the UE. The AMF callback URI for receiving SM context notification is used by the SMF (e.g., I-SMF, anchor SMF) to send notification of SM context status to the AMF.
Step 304: The I-SMF transmits an Nsmf_PDUSession_CreateSMContext Response to the AMF, wherein the Nsmf_PDUSession_CreateSMContext Response comprises a Cause and a SM Context ID. The SM Context ID identifies the SM context created in the I-SMF for the UE.
Step 305: The I-SMF selects an I-UPF to serve the PDU session based on the UE location.
Step 306: The I-SMF initiates an N4 Session Establishment procedure with the selected I-UPF.
Step 307: I-SMF transmits an Nsmf_PDUSession_Create Request to the anchor SMF, wherein the Nsmf_PDUSession_Create Request comprises the DNN, the S-NSSAI, the PDU Session ID, I-SMF Instance ID, the I-SMF SM Context ID and intermediate-core-network (ICN) tunnel info. The ICN tunnel info carries the I-UPF downlink (DL) Fully Qualified Tunnel Endpoint Identifier (F-TEID) which is used to identify GTP-U (GPRS tunneling protocol user plane) tunnel information of the I-UPF to receive downlink traffic.
Step 308: The anchor SMF sends an Nudm_SDM_Get Request to a unified data management (UDM), to retrieve Session Management Subscription data. The UDM sends back the requested data in a response message.
Step 309: The anchor SMF selects an UPF acting as the PSA.
Step 310: The anchor SMF initiates an N4 Session Establishment procedure with the selected UPF.
Step 311: The anchor SMF transmits an Nsm_PDUSession_Create Response to the I-SMF, wherein the Nsm_PDUSession_Create Response comprises quality of service (QOS) rules, QoS flow level, QoS parameters, QoS flow IDs (QFIs), QoS profiles, Session maximum bit rate (MBR) and H-UPF tunnel info. The H-UPF tunnel info carries the H-UPF GTP-U tunnel info of PSA UPF for receiving UL traffics.
Step 312: The I-SMF initiates an N4 Session Modification procedure with the I-UPF, to update the GTP-U tunnel info of the PSA UPF, i.e., UPF UL F-TEID.
Step 313: The I-SMF transmits an Namf_Communication_NIN2MessageTransfer Request to the AMF, wherein the Namf_Communication_NIN2MessageTransfer Request comprises the PDU Session ID, N2 SM information (PDU Session ID, QFI(s), QoS Profile(s), N3 CN Tunnel Info), N1 SM container (PDU Session Establishment Accept).

The N2 SM information carries information that the AMF shall forward to the RAN, including the N3 CN Tunnel Info carrying I-UPF UL F-TEID, the QFIs and QoS profiles used by the RAN to setup QoS flows. In an embodiment, the N1 SM container contains the PDU Session Establishment Accept that the AMF shall provide to the UE.
Step 314: The AMF transmits an N2 PDU Session Request to RAN, wherein the N2 PDU Session Request comprises N2 SM information, NAS message (PDU Session ID, N1 SM container (PDU Session Establishment Accept)). The AMF sends the NAS message containing PDU Session ID and PDU Session Establishment Accept targeted to the UE and the N2 SM information received from the SMF within the N2 PDU Session Request to the RAN.
Step 315: The RAN may issue AN specific signaling exchange with the UE that is related with the information received from SMF. For example, in case of a 3GPP RAN, an RRC Connection Reconfiguration may take place with the UE establishing the necessary RAN resources related to the QoS Rules for the PDU Session request. RAN forwards the NAS message (PDU Session ID, N1 SM container (PDU Session Establishment Accept)) to the UE. The RAN also allocates AN N3 tunnel information for the PDU Session.
Step 316: The RAN transmits a PDU Session Response to the AMF, wherein the N2 PDU Session Response comprises the PDU Session ID, Cause, N2 SM information (PDU Session ID, AN Tunnel Info, List of accepted/rejected QFI(s)).

The AN Tunnel Info corresponds to the Access Network address of the N3 tunnel corresponding to the PDU Session.
Step 317: The AMF transmits an Nsmf_PDUSession_UpdateSMContext to the I-SMF, wherein the Nsmf_PDUSession_UpdateSMContext Request comprises N2 SM information.

The AMF forwards the N2 SM information received from the RAN to the I-SMF. If the list of rejected QFI(s) is included in the N2 SM information, the SMF shall release the rejected QFI(s) associated QoS profiles.
Step 318: The I-SMF initiates an N4 Session Modification procedure with the I-UPF. The I-SMF provides RAN Tunnel Info to the I-UPF as well as the corresponding forwarding rules.
Step 319: The I-SMF sends an Nsmf_PDUSession_UpdateSMContext Response to the AMF.

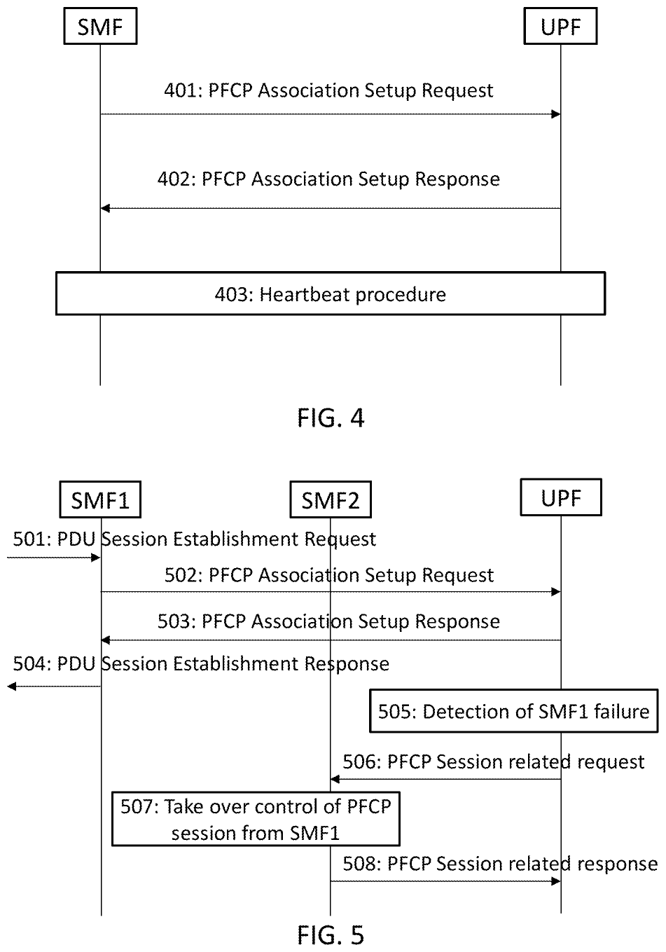

FIG. 4 shows a schematic diagram of a PFCP Association Setup procedure according to an embodiment of the present disclosure. In FIG. 4, the SMF selects a UPF and no PFCP association has been established yet. During the PFCP Association Setup procedure, the SMF provides its SMF Set information to the UPF. In an embodiment, the SMF initiates the PFCP Association Setup procedure to request setting up a PFCP Association towards the UPF prior to establishing the first PFCP session on this UPF. Specifically, the PFCP Association Setup procedure shown in FIG. 4 comprises:
Step 401: The SMF sends a PFCP Association Setup Request to the UPF. In an embodiment, the PFCP Association Setup Request comprises:
   a Node ID of the SMF: The Node ID may be set to a Fully qualified domain name (FQDN) representing the SMF, and/or
   an SMF Set ID: The SMF Set ID is set to an FQDN representing the SMF Set.
Step 402: When receiving the PFCP Association Setup Request, the UPF stores the Node ID of the SMF and stores the SMF Set ID if received. The UPF sends, to the SMF, a PFCP Association Setup Response including a successful cause if the PFCP association setup request is accepted.
Step 403: When the PFCP Association is successfully established between the SMF and the UPF, the UPF checks an available status of the SMF using a Heartbeat procedure.

FIG. 5 shows a schematic diagram of a procedure according to an embodiment of the present disclosure. In FIG. 5, the UPF detects a failure of an SMF and re-selects another SMF for taking over control of a PDU session from the failed SMF. Particularly, the procedure shown in FIG. 5 comprises:
Step 501: During a PDU session establishment procedure, an SMF1 receives a PDU session establishment request message from an AMF (not shown in FIG. 5). The PDU session establishment request message triggers the SMF1 to establish a PFCP Session with a UPF. The SMF1 selects the proper UPF based on a data network name (DNN) and other information.
Step 502: The SMF1 sends a PFCP Session Establishment Request to the selected UPF. In an embodiment, the SMF1 assigns a Session Endpoint Identifier (SEID) used for uniquely identifying the PFCP Session. Within the request message, the SMF1 includes a Control Plane Fully Qualified SEID (CP F-SEID). Note that the CP F-SEID is unique at least within one SMF set and may be unique within one SMF.
Step 503: The UPF sends back a PFCF Session Establishment Response message to the SMF1.
Step 504: The SMF1 responds to the AMF by sending a PDU Session Establishment Response message.
Step 505: The UPF keeps monitoring a status of the SMF1 by using the Heartbeat message. In this embodiment, the UPF may later detect that the SMF1 fails.
Step 506: When or after the UPF detects that the SMF1 fails (e.g., the SMF1 is not responsive), the UPF reselects another SMF within the SMF Set, e.g. the SMF2, based on the SMF Set information received during the PFCP Association Setup Procedure. The UPF initiates a PFCP Session related request (e.g., PFCP Session Report Request) towards the new SMF2.

When sending the request to the new SMF2, the UPF sets an SEID field in the PFCP header of the PFCP request to zero and includes the CP F-SEID assigned by the previous SMF1 in the request. The SEID set to zero gives an instruction/indication to the SMF2 that the UPF requests the SMF2 to take over this PFCP session. The CP F-SEID assigned by the previous SMF1 allows the new SMF2 to fetch PFCP session context of the UE, which may be stored in an external storage (e.g., UDSF).
Step 507: When or after receiving, from the UPF, a request with the SEID field set to zero and the CP F-SEID assigned by the previous SMF1, the reselected SMF2 takes over the control of the PFCP session from the previous SMF1.
Step 508: The SMF2 responds the UPF by sending a response corresponding to the PFCP Session related message.

In FIG. 5, the new SMF2 does not proactively update the new SMF information to the AMF, e.g., after the new SMF2 takes over the PFCP session. To avoid potential issues and enhance the procedure efficiency, methods allowing the reselected SMF (e.g., SMF2) to proactively update the SMF information for the PDU Session to other NFs (e.g., AMF and PCF) are provided in the present disclosure.

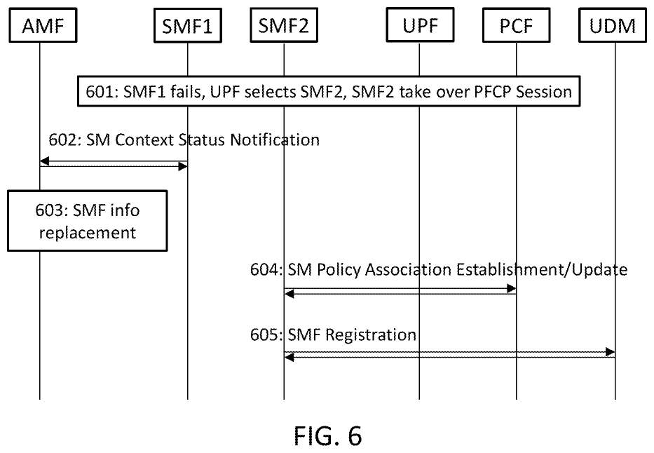

FIG. 6 shows a schematic diagram of a procedure according to an embodiment of the present disclosure. In FIG. 6, the reselected SMF (i.e., SMF2) informs the AMF that the reselected SMF has taken over control of the PDU Session(s) (e.g. the SM Context has been transferred to the reselected SMF after the UPF selects the new SMF to take over the control of the PFCP session).
Step 601: The UPF detects that the SMF1 fails (e.g., the SMF1 is not responsive or works abnormally) and reselects a new SMF (i.e., SMF2) to serve the PDU session.

In an embodiment, if SMF Set information was received during the PFCP Association Setup Procedure, the new SMF2 may be selected from the same SMF Set. As an alternative or in addition, if alternative SMF information was received during the PFCP Association Setup/Update Procedure, the new SMF may be selected from the alternative SMFs.

The UPF triggers a procedure to the new SMF2, to request the new SMF2 to take over control of the PFCP session, e.g., as described in the procedure shown in FIG. 5.
Step 602: The new (anchor) SMF2 sends an SM Context Status Notification Request message to the AMF, to proactively update the AMF with the new anchor SMF information.

In an embodiment, the SM Context Status Notification Request message comprises the ID of the PDU session.

In an embodiment, the new SMF ID (i.e., SMF ID of the SMF2 in this embodiment) is included in the SM Context Status Notification Request message, to indicate that the PDU session is taken over by the new anchor SMF2 (i.e. SMF reselected by the UPF).

In an embodiment, the SM Context Status Notification Request message may further include at least one of:
a new SMF Set ID, indicating the SMF Set ID of the new SMF;
   an old SMF ID, indicating the previous SMF serving the PDU session;
   an old SMF Set ID, indicating the SMF Set ID of the old SMF;
   the transfer indication. The transfer indication indicates that the SMF information replacement (i.e., replace old SMF with new SMF) applies to either one of the following: (a) single PDU session (related to the request and/or) served by the old SMF, (b) a batch of PDU sessions served by the old SMF. In an embodiment, by default, the missing of this transfer indication means that the SMF information replacement is applied to a single PDU session related to the request.

In an embodiment, no matter whether the reselected SMF2 and the previous SMF1 are within the same SMF Set or not, the old SMF ID is included together with the new SMF ID in the SM Context Status Notification Request message. In addition, the transfer indication may also be included in the SM Context Status Notification Request message, to indicate the scope of the SMF information replacement, especially if the SMF replacement is applied to a batch of PDU sessions (e.g., at least part of PDU sessions served by the SMF1).

In an embodiment, if the reselected SMF2 and the previous SMF1 are not within the same SMF Set, the new SMF Set ID and/or the old SMF ID and/or the old SMF Set ID is included together with the new SMF ID in the SM Context Status Notification Request message. In this embodiment, the transfer indication may also be included in the SM Context Status Notification Request message, to indicate the scope of SMF information replacement, especially if the SMF replacement is applied to a batch of PDU sessions.

In step 602, the AMF responds to the SMF2 by sending an SM Context Status Notification Response message to the SMF2.
Step 603: The AMF performs an SMF information replacement, upon/after receiving the SM Context Status Notification Request message carrying the SMF change information.

In an embodiment, if no transfer indication is included in the SM Context Status Notification Request message, the AMF updates the PDU session related information, to replace the old SMF ID with the new SMF ID.

In an embodiment, if the transfer indication is provided and set to indicate “a single PDU session”, the AMF updates the PDU session related information to replace the old SMF ID with the new SMF ID.

In an embodiment, if the transfer indication is provided and set to “a batch of PDU sessions”, the AMF updates the PDU session related information to all the impacted PDU sessions (e.g., the PDU sessions served by the SMF1), to replace the old SMF ID with the new SMF ID.
Step 604: The new anchor SMF2 initiates an SM Policy Association Establishment procedure or an SM Policy Association Update procedure to the PCF, by sending a Npcf_SMPolicyControl_Create request message or a Npcf_SMPolicyControl_Update request message.

In an embodiment, the Npcf_SMPolicyControl_Create request message or a Npcf_SMPolicyControl_Update request message comprises the ID of the PDU session.

As in step 602, the new SMF2 may include the new SMF ID in the request message to the PCF. In an embodiment, the request message further carries at least one of: new SMF Set ID, old SMF ID, old SMF Set ID, transfer indication. As an alternative or in addition, the new anchor SMF2 may also include a notification (uniform resource identifier) URI in the request message, wherein the notification URI is used to identify a recipient of SM policies update notifications sent by the PCF.

In an embodiment, the PCF responds to the SMF2 by sending a Npcf_SMPolicyControl_Create Response message or a Npcf_SMPolicyControl_Update Response message to the SMF2.

In step 604, the PCF performs an SMF information replacement, similarly as the AMF does in step 603.
Step 605: The new anchor SMF2 initiates an SMF Registration procedure to the UDM, by sending a Nudm_UECM_Registration request message.

In an embodiment, the Nudm_UECM_Registration request message comprises the ID of the PDU session.

As in step 602, the new SMF2 includes the new SMF ID in the request message transmitted to the UDM. In an embodiment, the request message may further carry at least one of: new SMF Set ID, old SMF ID, old SMF Set ID, transfer indication.

In an embodiment, the UDM responds to the SMF2 by sending a Nudm_UECM_Registration Response message to the SMF2. In addition, the UDM performs an SMF information replacement, similarly as the AMF in step 603.

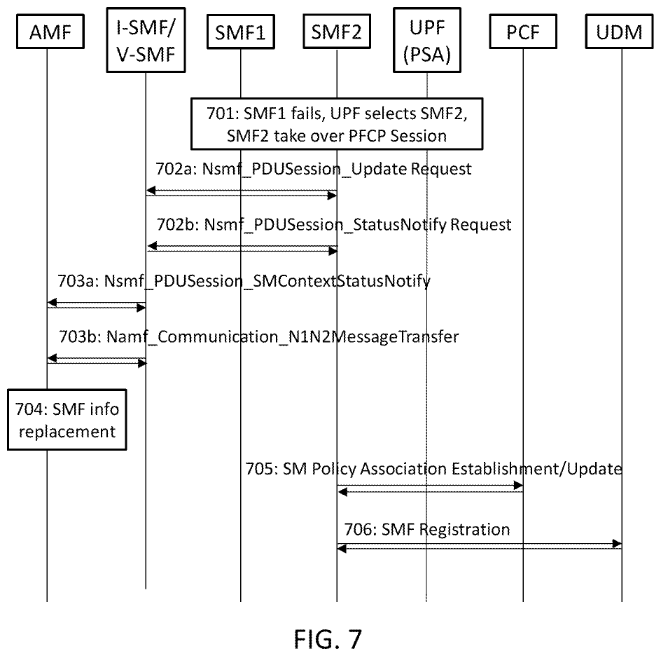

FIG. 7 shows a schematic diagram of a procedure according to an embodiment of the present disclosure. In FIG. 7, the I-SMF/V-SMF is involved in the PDU session. The reselected anchor SMF (i.e. SMF2) informs the AMF via the I-SMF/V-SMF that the reselected anchor SMF has taken over the control of the PDU Session (i.e. the PDU Session Context has been transferred to the reselected anchor SMF after the UPF selects the new anchor SMF to take over the control of the PFCP session).
Step 701: The UPF detects that the SMF1 fails (e.g. the SMF1 is not responsive) and reselects a new SMF2 to serve the PDU session.

If the SMF Set information was received during the PFCP Association Setup Procedure, the new SMF2 is selected from the same SMF Set. As an alternative or in addition, if alternative SMF information was received during the PFCP Association Setup/Update Procedure, the new SMF is selected from the alternative SMFs.

In step 701, the UPF triggers a procedure to the new SMF (i.e., SMF2) for requesting the new SMF to take over the PFCP session, similarly as the UPF in FIG. 5.

In this embodiment, the new anchor SMF2 performs either step 702a or step 702b, to notify the I-SMF/V-SMF the changes associated with the anchor SMF.
Step 702a: The new anchor SMF2 sends a Nsmf_PDUSession_Update Request message to the I-SMF/V-SMF. The Nsmf_PDUSession_Update Request message may comprise the ID of the PDU session. As in step 602, the new anchor SMF2 includes the new SMF ID in the request message transmitted to the I-SMF/V-SMF. The request message may further carry at least one of: new SMF Set ID, old SMF ID, old SMF Set ID, transfer indication.

In step 702a, the I-SMF/V-SMF responds to the SMF2 by sending a Nsmf_PDUSession_Update Response message to the SMF2.
Step 702b: The new anchor SMF2 sends a Nsmf_PDUSession_StatusNotify Request message to the I-SMF/V-SMF. The Nsmf_PDUSession_StatusNotify Request message may comprise the ID of the PDU session. As in step 602, the new anchor SMF2 includes the new SMF ID in the request message transmitted to the I-SMF/V-SMF. The request message may further carry at least one of: new SMF Set ID, old SMF ID, old SMF Set ID, transfer indication.

In step 702b, the I-SMF/V-SMF responds to the SMF2 by sending a Nsmf_PDUSession_StatusNotify Response message to the SMF2.

In the embodiment shown in FIG. 7, the I-SMF/V-SMF performs either step 703a or step 703b to notify the AMF about the changes associated with the anchor SMF.
Step 703a: The I-SMF/V-SMF sends a Nsmf_PDUSession_SMContextStatusNotify request message to the AMF, to proactively update the AMF with the new anchor SMF information. The Nsmf_PDUSession_SMContextStatusNotify request message may comprise the ID of the PDU session. The I-SMF/V-SMF includes the new SMF ID, and optionally at least one of: new SMF Set ID, old SMF ID, old SMF Set ID, transfer indication in the request message transmitted to the AMF, if such information are received from the new anchor SMF2.
Step 703b: The I-SMF/V-SMF sends a Namf_Communication_NIN2MessageTransfer request message to the AMF, to proactively update the AMF with the new anchor SMF information. The Namf_Communication_NIN2MessageTransfer request message may comprise the ID of the PDU session. The I-SMF/V-SMF includes the new SMF ID and optionally at least one of the new SMF Set ID, old SMF ID, old SMF Set ID, transfer indication in the request message transmitted to the AMF, if such information are received from the new anchor SMF2.
Step 704: The AMF performs an SMF information replacement, as the AMF in step 603.
Step 705: The new anchor SMF2 initiates an SM Policy Association Establishment procedure or SM Policy Association Update procedure by sending a Npcf_SMPolicyControl_Create request message or a Npcf_SMPolicyControl_Update request message to the PCF. The Npcf_SMPolicyControl_Create request message or the Npcf_SMPolicyControl_Update request message may comprise the ID of the PDU session. As the SMF2 in step 604, the new anchor SMF2 includes the new SMF ID in the request message to the PCF and the request message optionally further carries at least one of: new SMF Set ID, old SMF ID, old SMF Set ID, transfer indication. The new anchor SMF2 may also include a notification URI in the message, wherein the notification URI is used to identify the recipient of SM policies update notifications sent by the PCF.

In step 705, the PCF responds the SMF2 by sending a Npcf_SMPolicyControl_Create Response message or a Npcf_SMPolicyControl_Update Response message to the SMF2. In addition, the PCF performs SMF information replacement, similarly as the AMF in step 603.
Step 706: The new anchor SMF2 initiates an SMF Registration procedure by sending the Nudm_UECM_Registration request message to the UDM. The Nudm_UECM_Registration request message may comprise the ID of the PDU session. As in step 605, the new anchor SMF2 includes the new SMF ID in the request message to the UDM, and the request message may further carry at least one of: new SMF Set ID, old SMF ID, old SMF Set ID, transfer indication.

In step 706, the UDM responds to the SMF2 by sending a Nudm_UECM_Registration Response message to the SMF2. The UDM performs an SMF information replacement, as the AMF in step 603.

In an embodiment of the present disclosure, the new anchor SMF (e.g. SMF2 in FIGS. 5 to 7) receives the PFCP Session related message from the UPF and takes over control of the PFCP Session from the old SMF (e.g. SMF1 in FIGS. 5 to 7). For example, the PFCP Session related message indicates the new anchor SMF to take over control of the PFCP session. As an alternative or in addition, the PFCP Session related message indicates that the old SMF serving the PFCP Session fails/works abnormally. Under such conditions, the new anchor SMF sends the SMF change information to connected network function(s) related to the PDU session, such as AMF, Intermediate SMF, PCF and/or UDM.

In an embodiment, the SMF change information includes the new SMF ID, used to indicate the PDU session is taken over by the new anchor SMF (i.e. SMF reselected by the UPF).

In an embodiment, the SMF change information may further include at least one of: the old SMF ID, the new SMF Set ID, the old SMF Set ID, the transfer indication.

In an embodiment, the transfer indication indicates that the SMF information replacement (i.e. replace old SMF with new SMF) applies to either a single PDU session served by the old SMF or a batch of PDU sessions served by the old SMF.

In an embodiment of the present disclosure, an Intermediate SMF may receive the SMF change information (associated with a PDU session) from the new anchor SMF and sends the SMF change information to the corresponding AMF.

In an embodiment, the SMF change information includes the new SMF ID, used to indicate the PDU session is taken over by the new anchor SMF (i.e. SMF reselected by the UPF).

In an embodiment, the SMF change information may further include at least one of: the old SMF ID, the new SMF Set ID, the old SMF Set ID, the transfer indication.

In an embodiment, the transfer indication indicates that the SMF information replacement (i.e. replace old SMF with new SMF) applies to either a single PDU session served by the old SMF or a batch of PDU sessions served by the old SMF.

In an embodiment of the present disclosure, the AMF/PCF/UDM receives the SMF change information (associated with a PDU session). Note that the AMF may receive the SMF change information directly from the new anchor SMF if no Intermediate SMF is involved. As an alternative, the AMF may receive the SMF change information from the Intermediate SMF if the Intermediate SMF is involved. In addition, the PCF/UDM receives the SMF change information from the new anchor SMF. Based on the SMF change information, the AMF/PCF/UDM updates the SMF information for the impacted PDU Session(s).

In an embodiment, the SMF change information includes the new SMF ID, used to indicate the PDU session is taken over by the new anchor SMF (i.e., SMF reselected by the UPF).

In an embodiment, the SMF change information may further include at least one of: the old SMF ID, the new SMF Set ID, the old SMF Set ID, the transfer indication.

In an embodiment, the transfer indication indicates that the SMF information replacement (i.e., replace old SMF with new SMF) applies to either a single PDU session served by the old SMF or a batch of PDU sessions served by the old SMF.

In an embodiment of the SMF change information having no transfer indication, the AMF/PCF/UDM updates the PDU session related information of the PDU session corresponding to the SMF change information, to replace the old SMF ID with the new SMF ID.

In an embodiment of the SMF change information having the transfer indication set to/indicate ‘a single PDU session’, the AMF/PCF/UDM updates the PDU session related information corresponding to the SMF change information, to replace the old SMF ID with the new SMF ID.

In an embodiment of the SMF change information having the transfer indication set to/indicate ‘a batch of PDU sessions’, the AMF/PCF/UDM updates the PDU session related information to all the impacted PDU sessions, to replace the old SMF ID with the new SMF ID.

In an embodiment, the SMF change information received by the PCF may further include notification URI which identifies the recipient of SM policies update notification sent by the PCF.

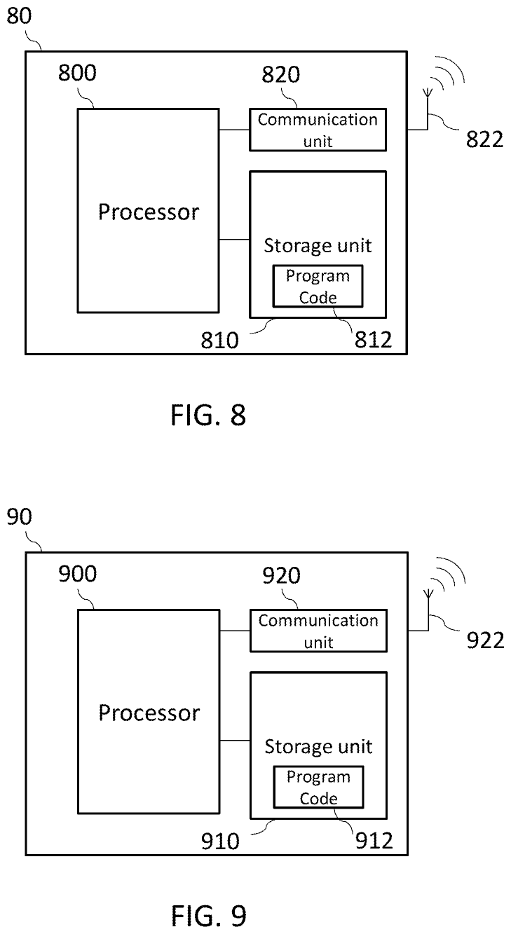

FIG. 8 relates to a schematic diagram of a wireless terminal 80 according to an embodiment of the present disclosure. The wireless terminal 80 may be a user equipment (UE), a mobile phone, a laptop, a tablet computer, an electronic book or a portable computer system and is not limited herein. The wireless terminal 80 may include a processor 800 such as a microprocessor or Application Specific Integrated Circuit (ASIC), a storage unit 810 and a communication unit 820. The storage unit 810 may be any data storage device that stores a program code 812, which is accessed and executed by the processor 800. Embodiments of the storage unit 812 include but are not limited to a subscriber identity module (SIM), read-only memory (ROM), flash memory, random-access memory (RAM), hard-disk, and optical data storage device. The communication unit 820 may a transceiver and is used to transmit and receive signals (e.g., messages or packets) according to processing results of the processor 800. In an embodiment, the communication unit 820 transmits and receives the signals via at least one antenna 822 shown in FIG. 8.

In an embodiment, the storage unit 810 and the program code 812 may be omitted and the processor 800 may include a storage unit with stored program code.

The processor 800 may implement any one of the steps in exemplified embodiments on the wireless terminal 80, e.g., by executing the program code 812.

The communication unit 820 may be a transceiver. The communication unit 820 may as an alternative or in addition be combining a transmitting unit and a receiving unit configured to transmit and to receive, respectively, signals to and from a wireless network node (e.g., a base station).

FIG. 9 relates to a schematic diagram of a wireless network node 90 according to an embodiment of the present disclosure. The wireless network node 90 may be a satellite, a base station (BS), a network entity, a Mobility Management Entity (MME), Serving Gateway (S-GW), Packet Data Network (PDN) Gateway (P-GW), a radio access network (RAN) node, a next generation RAN (NG-RAN) node, a gNB, an eNB, a gNB central unit (gNB-CU), a gNB distributed unit (gNB-DU) a data network, a core network or a Radio Network Controller (RNC), and is not limited herein. In addition, the wireless network node 90 may comprise (perform) at least one network function such as an access and mobility management function (AMF), a session management function (SMF), a user place function (UPF), a policy control function (PCF), an application function (AF), unified data management (UDM), etc. The wireless network node 90 may include a processor 900 such as a microprocessor or ASIC, a storage unit 910 and a communication unit 920. The storage unit 910 may be any data storage device that stores a program code 912, which is accessed and executed by the processor 900. Examples of the storage unit 912 include but are not limited to a SIM, ROM, flash memory, RAM, hard-disk, and optical data storage device. The communication unit 920 may be a transceiver and is used to transmit and receive signals (e.g. messages or packets) according to processing results of the processor 900. In an example, the communication unit 920 transmits and receives the signals via at least one antenna 922 shown in FIG. 9.

In an embodiment, the storage unit 910 and the program code 912 may be omitted. The processor 900 may include a storage unit with stored program code.

The processor 900 may implement any steps described in exemplified embodiments on the wireless network node 90, e.g., via executing the program code 912.

The communication unit 920 may be a transceiver. The communication unit 920 may as an alternative or in addition be combining a transmitting unit and a receiving unit configured to transmit and to receive, respectively, signals to and from a wireless terminal (e.g. a user equipment or another wireless network node).

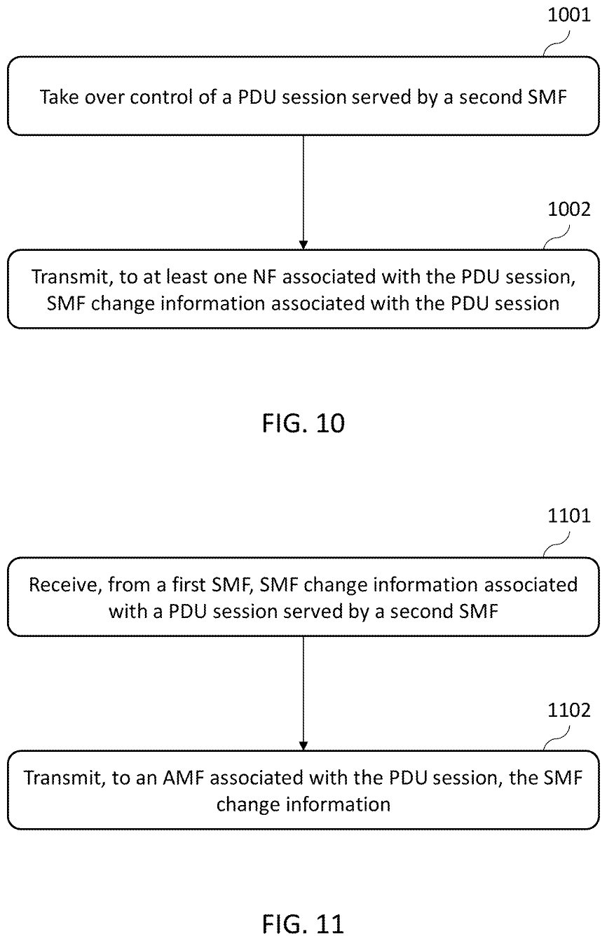

FIG. 10 shows a flowchart of a method according to an embodiment of the present disclosure. The method shown in FIG. 10 may be used in a first SMF (e.g., a wireless device comprising the SMF or a wireless device performing at least part of functionalities of the SMF) and comprises the following steps:
Step 1001: Take over control of a PDU session served by a second SMF.
Step 1002: Transmit, to at least one NF associated with the PDU session, SMF change information associated with the PDU session.

In the method shown in FIG. 10, the first SMF takes over control of a PDU session originally served by a second SMF. For example, a failure of the second SMF may be detected by a UPF and the first SMF may receive a request (e.g., PFCP session related request) indicating the first SMF to take over control of the PDU session (e.g. corresponding PFCP session) from the second SMF. Under such conditions, the first SMF transmits SMF change information associated with the PDU session to at least one NF associated with the PDU session, to proactively update the SMF information of the PDU session.

In an embodiment, the SMF change information may comprise or be associated with an ID of the PDU session, to identify the PDU session.

In an embodiment, the SMF change information comprises an ID of the first SMF.

In an embodiment, the SMF change information further comprises at least one of:
an ID of the second SMF,
an ID of a first SMF set comprising the first SMF,
an ID of a second SMF set comprising the second SMF, or
a transfer indication indicating at least one PDU session on which the SMF change information is applied.

In an embodiment, the transfer indication indicates a single PDU session or a plurality of PDU sessions served by the second SMF.

In an embodiment of the SMF change information having no transfer indication, the SMF change information is applied in a default way (e.g., on only the PDU session or all the PDU sessions served by the second SMF).

In an embodiment, the at least one NF comprises AMF and/or PCF and/or UDM and/or I-SMF/V-SMF.

In an embodiment of the SMF change information being transmitted to the PCF, the first SMF may further comprise a notification URI of a recipient of an SM policy update notification in the SMF change information.

FIG. 11 shows a schematic diagram of a method according to an embodiment of the present disclosure. The method shown in FIG. 11 may be used in an Intermediate SMF (e.g., I-SMF/V-SMF, a wireless device comprising the I-SMF/V-SMF or a wireless device performing at least part of functionalities of the I-SMF/V-SMF) and comprises the following steps:
Step 1101: Receive, from a first SMF, SMF change information associated with a PDU session served by a second SMF.
Step 1102: Transmit, to an AMF associated with the PDU session, the SMF change information.

In the method of FIG. 11, the Intermediate SMF receives SMF change information associated with a PDU session served by a second SMF from a first SMF. In this case, the Intermediate SMF transmits/forwards the received SMF change information to the AMF associated with the PDU session.

In an embodiment, the SMF change information may comprise or be associated with an ID of the PDU session, to identify the PDU session.

In an embodiment, the SMF change information comprises an ID of the first SMF.

In an embodiment, the SMF change information further comprises at least one of:
an ID of the second SMF,
an ID of a first SMF set comprising the first SMF,
an ID of a second SMF set comprising the second SMF, or
a transfer indication indicating at least one PDU session on which the SMF change information is applied.

In an embodiment, the transfer indication indicates a single PDU session or a plurality of PDU sessions served by the second SMF.

In an embodiment of the SMF change information having no transfer indication, the SMF change information is applied in a default way (e.g., on only the PDU session or all the PDU sessions served by the second SMF).

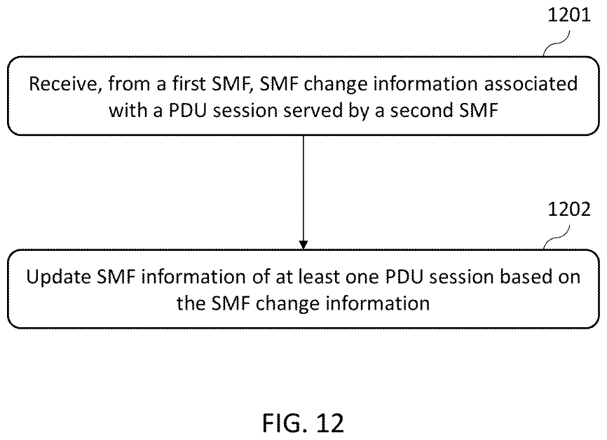

FIG. 12 shows a flowchart of a method according to an embodiment of the present disclosure. The method shown in FIG. 12 may be used in an NF (e.g., AMF/PCF/UDM, a wireless device comprising AMF/PCF/UDM, a wireless device performing at least part of functionalities of AMF/PCF/UDM) and comprises the following steps:
Step 1201: Receive, from a first SMF, SMF change information associated with a PDU session served by a second SMF.
Step 1202: Update SMF information of at least one PDU session based on the SMF change information.

In the method shown in FIG. 12, the NF receives SMF change information associated with a PDU session served by a second SMF from a first SMF. Based on the SMF change information, the NF updates SMF information of at least one PDU session (e.g., only the PDU session associated with the SMF change information or all the PDU sessions served by the second SMF).

In an embodiment, the SMF change information may comprise or be associated with an ID of the PDU session, to identify the PDU session.

In an embodiment, the SMF change information comprises an ID of the first SMF.

In an embodiment, the SMF change information further comprises at least one of:
an ID of the second SMF,
an ID of a first SMF set comprising the first SMF,
an ID of a second SMF set comprising the second SMF, or
a transfer indication indicating at least one PDU session on which the SMF change information is applied.

In an embodiment, the transfer indication indicates a single PDU session or a plurality of PDU sessions served by the second SMF.

In an embodiment of the SMF change information having no transfer indication, the SMF change information is applied in a default way. For example, the NF may update the SMF information of only the PDU session or all the PDU sessions served by the second SMF according to the SMF change information.

In an embodiment of the NF being the AMF, the SMF change information may be received from an intermediate SMF.

In an embodiment of the NF being the PCF, the SMF change information may further comprise a notification URI of a recipient of an SM policy update notification.

While various embodiments of the present disclosure have been described above, it should be understood that they have been presented by way of example only, and not by way of limitation. Likewise, the various diagrams may depict an example architectural or configuration, which are provided to enable persons of ordinary skill in the art to understand example features and functions of the present disclosure. Such persons would understand, however, that the present disclosure is not restricted to the illustrated example architectures or configurations, but can be implemented using a variety of alternative architectures and configurations. Additionally, as would be understood by persons of ordinary skill in the art, one or more features of one embodiment can be combined with one or more features of another embodiment described herein. Thus, the breadth and scope of the present disclosure should not be limited by any one of the above-described example embodiments.

It is also understood that any reference to an element herein using a designation such as “first,” “second,” and so forth does not generally limit the quantity or order of those elements. Rather, these designations can be used herein as a convenient means of distinguishing between two or more elements or instances of an element. Thus, a reference to first and second elements does not mean that only two elements can be employed, or that the first element must precede the second element in some manner.

Additionally, a person having ordinary skill in the art would understand that information and signals can be represented using any one of a variety of different technologies and techniques. For example, data, instructions, commands, information, signals, bits and symbols, for example, which may be referenced in the above description can be represented by voltages, currents, electromagnetic waves, magnetic fields or particles, optical fields or particles, or any combination thereof.

A skilled person would further appreciate that any one of the various illustrative logical blocks, units, processors, means, circuits, methods and functions described in connection with the aspects disclosed herein can be implemented by electronic hardware (e.g., a digital implementation, an analog implementation, or a combination of the two), firmware, various forms of program or design code incorporating instructions (which can be referred to herein, for convenience, as “software” or a “software unit”), or any combination of these techniques.

To clearly illustrate this interchangeability of hardware, firmware and software, various illustrative components, blocks, units, circuits, and steps have been described above generally in terms of their functionality. Whether such functionality is implemented as hardware, firmware or software, or a combination of these techniques, depends upon the particular application and design constraints imposed on the overall system. Skilled artisans can implement the described functionality in various ways for each particular application, but such implementation decisions do not cause a departure from the scope of the present disclosure. In accordance with various embodiments, a processor, device, component, circuit, structure, machine, unit, etc. can be configured to perform one or more of the functions described herein. The term “configured to” or “configured for” as used herein with respect to a specified operation or function refers to a processor, device, component, circuit, structure, machine, unit, etc. that is physically constructed, programmed and/or arranged to perform the specified operation or function.

Furthermore, a skilled person would understand that various illustrative logical blocks, units, devices, components and circuits described herein can be implemented within or performed by an integrated circuit (IC) that can include a general purpose processor, a digital signal processor (DSP), an application specific integrated circuit (ASIC), a field programmable gate array (FPGA) or other programmable logic device, or any combination thereof. The logical blocks, units, and circuits can further include antennas and/or transceivers to communicate with various components within the network or within the device. A general purpose processor can be a microprocessor, but in the alternative, the processor can be any conventional processor, controller, or state machine. A processor can also be implemented as a combination of computing devices, e.g., a combination of a DSP and a microprocessor, a plurality of microprocessors, one or more microprocessors in conjunction with a DSP core, or any other suitable configuration to perform the functions described herein. If implemented in software, the functions can be stored as one or more instructions or code on a computer-readable medium. Thus, the steps of a method or algorithm disclosed herein can be implemented as software stored on a computer-readable medium.

Computer-readable media includes both computer storage media and communication media including any medium that can be enabled to transfer a computer program or code from one place to another. A storage media can be any available media that can be accessed by a computer. By way of example, and not limitation, such computer-readable media can include RAM, ROM, EEPROM, CD-ROM or other optical disk storage, magnetic disk storage or other magnetic storage devices, or any other medium that can be used to store desired program code in the form of instructions or data structures and that can be accessed by a computer.

In this document, the term “unit” as used herein, refers to software, firmware, hardware, and any combination of these elements for performing the associated functions described herein. Additionally, for purpose of discussion, the various units are described as discrete units; however, as would be apparent to one of ordinary skill in the art, two or more units may be combined to form a single unit that performs the associated functions according embodiments of the present disclosure.

Additionally, memory or other storage, as well as communication components, may be employed in embodiments of the present disclosure. It will be appreciated that, for clarity purposes, the above description has described embodiments of the present disclosure with reference to different functional units and processors. However, it will be apparent that any suitable distribution of functionality between different functional units, processing logic elements or domains may be used without detracting from the present disclosure. For example, functionality illustrated to be performed by separate processing logic elements, or controllers, may be performed by the same processing logic element, or controller. Hence, references to specific functional units are only references to a suitable means for providing the described functionality, rather than indicative of a strict logical or physical structure or organization.

Various modifications to the implementations described in this disclosure will be readily apparent to those skilled in the art, and the general principles defined herein can be applied to other implementations without departing from the scope of the claims. Thus, the disclosure is not intended to be limited to the implementations shown herein, but is to be accorded the widest scope consistent with the novel features and principles disclosed herein, as recited in the claims below.

1. A wireless communication method for use in a first session management function (SMF), the wireless communication method comprising:
receiving, from a user plane function, a request related to a protocol data unit (PDU) session served by a second SMF;
taking over control of the PDU, session from the second SMF, and
transmitting, to at least one network function associated with the PDU session, SMF change information associated with the PDU session,
wherein the SMF change information comprises an identifier of the first SMF.

2. The wireless communication method of claim 1, wherein the at least one network function comprises an intermediate SMF or a visited SMF.

3. The wireless communication method of claim 1, wherein the request related to a PDU session comprises a Session Endpoint Identifier (SEID) and a Control Plane Fully Qualified SEID (CP F-SEID).

4. The wireless communication method of claim 3, wherein the SEID is set to 0, and the CP F-SEID is assigned by the second SMF.

5. A wireless communication method for use in an intermediate session management function (SMF), the wireless communication method comprising:
receiving, from a first SMF, SMF change information associated with a protocol data unit (PDU) session served by a second SMF, and
transmitting, to an access and mobility management function associated with the PDU session, the SMF change information,
wherein the SMF change information comprises an identifier of the first SMF.

6. The wireless communication method of claim 5, wherein the SMF change information comprises a transfer indication indicating a plurality of PDU sessions served by the second SMF, and
wherein updating the SMF information of the at least one PDU session based on the SMF change information comprises:
updating the SMF information of the plurality of PDU sessions served by the second SMF based on the SMF change information.

7. A wireless communication method for a network function, the wireless communication method comprising:
receiving, from a first session management function (SMF), SMF change information associated with a protocol data unit (PDU) session served by a second SMF, and
updating SMF information of at least one PDU session based on the SMF change information,
wherein the SMF change information comprises an identifier of the first SMF.

8. The wireless communication method of claim 7, wherein the SMF change information comprises a transfer indication indicating a plurality of PDU sessions served by the second SMF, and
wherein updating the SMF information of the at least one PDU session based on the SMF change information comprises:
updating the SMF information of the plurality of PDU sessions served by the second SMF based on the SMF change information.

9. The wireless communication method of claim 7, wherein the network function comprises at least one of an access and mobility management function, a policy control function or a unified data management.

10. The wireless communication method of claim 7, wherein the network function comprises an access and mobility management function, and
wherein the SMF change information is received via an intermediate SMF.

11. A wireless device having a first session management function (SMF), the wireless device comprising:
a communication unit, configured to receive, from a user plane function, a request related to a protocol data unit (PDU) session served by a second SMF;
at least one processor, configured to take over control of the PDU session from the second SMF, and
wherein the communication unit, is further configured to transmit, to at least one network function associated with the PDU session, SMF change information associated with the PDU session, wherein the SMF change information comprises an identifier of the first SMF.

12. The wireless device of claim 11, wherein the at least one network function comprises an intermediate SMF or a visited SMF.

13. The wireless device of claim 11, wherein the request related to a PDU session comprises a Session Endpoint Identifier (SEID) and a Control Plane Fully Qualified SEID (CP F-SEID).

14. The wireless device of claim 13, wherein the SEID is set to 0, and the CP F-SEID is assigned by the second SMF.
